(19) United States
(12) Patent Application Publication
(10) Pub. No.: US 2021/0367342 A1
(43) Pub. Date: Nov. 25, 2021

(54) Optimized Near-Field Communication Antenna Structure for Reduced Coupling

(71) Applicant: Google LLC, Mountain View, CA (US)

(72) Inventors: Hung-Chi Chiu, New Taipei City (TW); Wei-Yang Wu, New Taipei City (TW); Che-Ting Yeh, New Taipei City (TW); Li Wang, Mountain View, CA (US)

(73) Assignee: Google LLC, Mountain View, CA (US)

(21) Appl. No.: 17/397,167

(22) Filed: Aug. 9, 2021

Related U.S. Application Data
(60) Provisional application No. 63/230,396, filed on Aug. 6, 2021.

(51) Int. Cl. H01Q 7/06; H02J 50/40; H04B 5/00

(52) U.S. Cl. CPC H01Q 7/06; H04B 5/0075; H02J 50/402

(57) ABSTRACT

An optimized near-field communication (NFC) antenna structure for reduced coupling with a wireless charging (WLC) coil of a computing device includes the WLC coil and an NFC coil that at least partially overlaps the WLC coil. The NFC coil of the optimized structure may include two sections that partially overlap the WLC coil and meet, over the WLC coil, at an angle to reduce coupling between the WLC coil and the NFC coil. The angled shape of the NFC coil may be implemented in various shapes resulting in one or more angles such that the first and second sections of the NFC coil are angled with respect to one another over the WLC coil. The combination or shape of the angles of the NFC coil, as well as NFC coil position relative to the WLC coil, may be optimized to reduce coupling between the NFC coil and the WLC coil.

### RELATED APPLICATION

This application claims priority to U.S. Provisional Patent Application Ser. No. 63/230,396 filed on Aug. 6, 2021, the disclosures of which are incorporated by reference herein in their entireties.

### SUMMARY

This disclosure describes an optimized near-field communication (NFC) antenna structure for reduced coupling between an NFC coil of the antenna structure and a wireless charging (WLC) coil of a computing device (e.g., a smartphone). In aspects, the optimized NFC antenna structure includes the WLC coil and the NFC coil, which at least partially overlaps the WLC coil. The NFC coil of the optimized structure may include two sections that partially overlap the WLC coil and meet, over the WLC coil, at an angle to reduce coupling between the WLC coil and the NFC coil. The NFC coil may be partially disposed over the WLC coil such that a magnetic field generated by the NFC coil is induced into the WLC coil through mutual induction or coupling between the respective coils. In aspects, a geometry, shape, or position of the NFC coil is optimized to reduce the coupling between the respective coils, which may prevent operation of the NFC coil from impairing or interfering with operation of the WLC coil.

This disclosure describes various aspects of an optimized NFC antenna structure for reduced coupling. In aspects, a computing device includes a housing that substantially defines a housing plane of the computing device, a first coil, and a second coil. The computing device also includes a battery positioned within the housing and circuitry coupled to the battery. The first coil is coupled to the circuitry and includes a first conductor having a first shape that is positioned substantially parallel to the housing plane and at least partially within the housing, the first shape forming a winding. The second coil is coupled to the circuitry and includes a second conductor forming a second shape that is positioned substantially parallel to the housing plane and at least partially within the housing. The second coil is usable to generate a magnetic field when subject to an electric current. The second coil at least partially overlaps the first coil. The second shape of the second coil has at least three sections that include a first section that does not overlap the first coil, a second section coupled to a first end of the first section of the second coil, with the second section extending over the first coil. A third section of the second coil is coupled to a second end of the first section of the second coil, with the third section extending over the first coil and being coupled to the second section of the second coil. In aspects, an angle between the second section and third section of the second coil is in a range of 80 degrees to 160 degrees. In aspects, an optimized NFC antenna structure includes the first coil, the second coil, and the dielectric assembly, which may be embodied in a computing device to enable near-field communication and wireless charging.

### BRIEF DESCRIPTION OF THE DRAWINGS

An optimized NFC antenna structure for reduced coupling is described with reference to the following drawings:

FIG. 1 illustrates example implementations of a computing device that is capable of contactless communication with a receiving computing device and wireless charging;

FIG. 2 illustrates an example configuration of an optimized NFC antenna structure for reduced coupling in accordance with one or more aspects;

FIG. 3 illustrates cross-sectional views of an example optimized NFC antenna structure that includes a WLC coil and an NFC coil implemented in accordance with one or more aspects;

FIG. 4 illustrates cross-sectional views of another example optimized NFC antenna structure that includes a WLC coil and an NFC coil implemented in accordance with one or more aspects;

FIG. 5 illustrates a plan view of an example optimized NFC antenna structure implemented in accordance with one or more aspects;

FIG. 6 illustrates a plan view of another example optimized NFC antenna structure implemented in accordance with one or more aspects;

FIG. 7 illustrates a plan view of yet another example optimized NFC antenna structure implemented in accordance with one or more aspects; and

FIG. 8 illustrates a plan view of an example optimized NFC antenna structure that includes an asymmetric NFC coil in accordance with one or more aspects.

The same numbers are used throughout the drawings to reference like features and components.

### DETAILED DESCRIPTION

An optimized near-field communication (NFC) antenna structure may include an NFC antenna for contactless communication and a wireless charging coil (WLC) for receiving power from and/or transmitting power to another device. In aspects, the optimized NFC antenna structure may be used by a computing device to communicate with another computing device over a short distance (e.g., a distance less than 4 centimeters (cm)) without contact. The computing device may provide a current to the NFC antenna to generate radiation that may be at least partially received by a receiving NFC antenna of another computing device. For example, a smartphone may transfer payment information to an electronic reader by sending an alternating current to an NFC antenna of the smartphone to generate magnetic fields. When the smartphone is positioned near the electronic reader, changes in the magnetic flux (e.g., associated with the generated magnetic fields) over time may induce a current into a receiving NFC antenna of the electronic reader through inductive coupling to transfer the payment information. Alternatively or additionally, the computing device may use the WLC to provide power to other devices, which may include peripheral devices or other computing devices. In some cases, the computing device may use the WLC coil to receive power from another device, such as a wireless charger.

To improve performance of contactless communications using NFC antennas or wireless power transfer using the WLC, some manufacturers include one or more dielectric sheets in an optimized NFC antenna structure to localize magnetic fields and reduce magnetic-field loss. These dielectric sheets may also act as an insulator to protect circuitry of the computing device. In some cases, a respective magnetic field of the NFC antenna and the WLC couples with the other antenna or coil, which may impair or prevent operation of contactless communication or wireless charging functions of the computing device. Thus, in aspects of optimized near-field communication (NFC) antenna structure, a geometry of the NFC antenna (e.g., NFC coil) may be configured to reduce coupling between the co-located coils of the optimized antenna structure to improve contactless communication or wireless charging performance of a computing device.

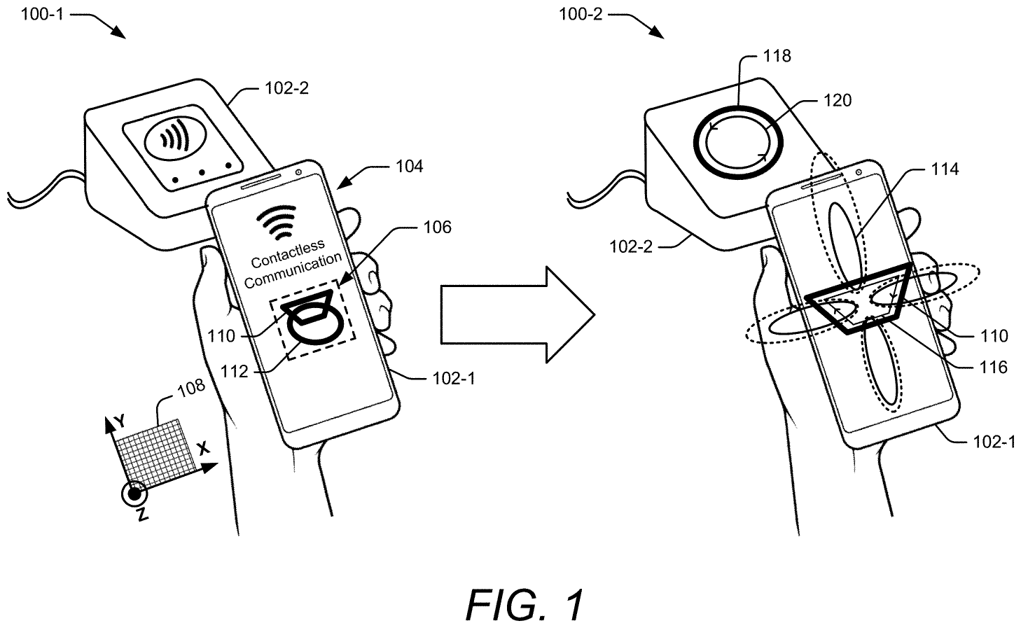

FIG. 1 illustrates, at 100-1 and 100-2, example implementations of a computing device 102-1 used to perform a contactless communication with a receiving computing device 102-2. The computing device may be a mobile electronic device with a screen, input device (e.g., touchscreen and hardware switches), and a battery. While the computing device 102-1 depicted in FIG. 1 is a smartphone, other types of computing devices may also support the techniques described herein. A computing device 102 may include, for instance, a tablet, a laptop, a computing watch, computing glasses, a home-service device, a drone, a netbook, an e-reader, a virtual-reality headset, and/or another home appliance. The computing device 102 may be wearable or non-wearable but mobile. The computing device 102 may include one or more processors, receivers, transmitters, circuitry, and so forth.

As shown at 100-1, the computing device 102-1 may include a housing 104 that at least partially covers (e.g., encloses, protects) an optimized NFC antenna structure 106 and substantially defines a housing plane 108 (e.g., an XY plane across a front surface (screen) or back surface of the computing device 102-1). In this example, the optimized NFC antenna structure 106 includes an NFC antenna 110 (e.g., an NFC coil) and a WLC 112 that are oriented substantially parallel to the housing plane 108 and may be respectively positioned to at least partially overlap one another. In aspects, the computing device 102-2 includes a battery (not shown) positioned within the housing 104 and circuitry (not shown) that couples various components of the computing device. For example, the circuitry can couple a transceiver of the computing device 102-2 to the NFC antenna 110 or couple the battery to the WLC 112 to enable wireless reception or transmission of power by the computing device.

Example implementation at 100-2 illustrates the computing device 102-1 positioned near a receiving computing device 102-2 and generating magnetic fields 114 when a current 116 is supplied to the NFC antenna 110. Changes in the magnetic flux over time, associated with these magnetic fields 114, may induce an electromotive force (EMF) into a receiving antenna 118 in accordance with Faraday's law of induction. This EMF may correspond to an induced current 120 associated with, for instance, encrypted information used to complete a contactless payment.

Some preceding NFC antennas (e.g., rectangular shaped coils), however, may generate magnetic fields 114 that excessively couple with a WLC co-located with the NFC antenna, which may impair or disrupt operation of a wireless charging circuit coupled to the WLC. For example, magnetic fields generated by NFC polling transmissions may prevent the wireless charging circuit coupled to the WLC from detecting another device or result in false detection of another source of wireless charging magnetic fields. In some cases, this can cause the wireless charging circuit to enter a timeout state or to cease detection operations. As a result, the user may be prevented from accessing wireless charging functionalities of a computing device when the NFC antenna is active for various polling or communication operations. Consequently, barriers may exist that prevent users from efficiently using contactless communication and wireless charging functionalities of a computing device. This disclosure describes an optimized NFC antenna structure that utilizes various geometries and arrangements of an NFC antenna (NFC coil), a WLC, and dielectric assembly to reduce coupling of a magnetic field between the NFC antenna and the WLC. By so doing, a computing device may operate an NFC transceiver with less or minimal interference to wireless charging circuitry of the computing device.

In general, an NFC antenna 110 or WLC 112 may refer to an electromagnetic coil comprising a conductive material (e.g., copper wire or copper traces) that enables the flow of current at a resonant frequency, for instance, of 13.56 Megahertz (13.56 MHz) for NFC or 150 kilohertz (150 kHz) for wireless charging. In aspects, the WLC 112 may be implemented generally as a conductive coil (e.g., wires or traces) with an appropriate resonance for wireless charging operations, which may include transmitting wireless power to another device or receiving wireless power from a power source. In aspects, the WLC 112 may be implemented as any suitable shape, which may include a circle, an ellipse, a rectangle, a rectangle with rounded corners, a square with rounded corners, a stadium, a polygon with rounded corners, or the like.

The electrical characteristics of the NFC antenna may include an inductance, a resistance, and a capacitance based on an associated topography (e.g., dimensions, number of windings, spacing). For example, some NFC antennas are configured for an inductance of 200-600 nanohenry (nH) with a quality factor of approximately 8-15 and a self-resonant frequency greater than 30 MHz. NFC antennas may be used to read and/or write information on NFC tags, communicate with another NFC antenna of a second device, and/or perform card emulation for transactions including payments or ticketing.

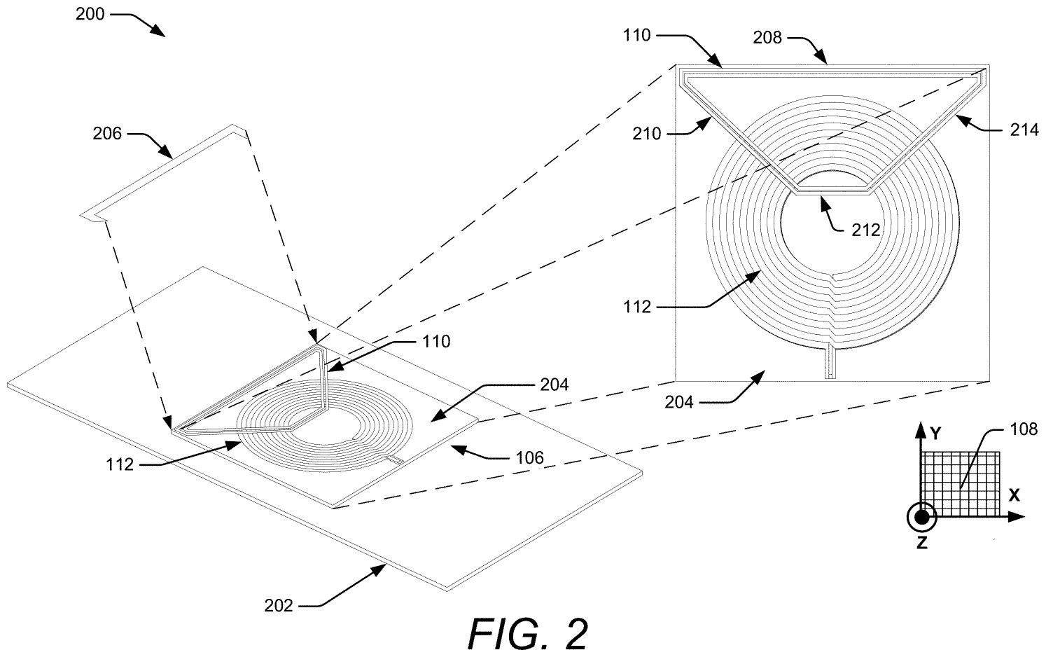

FIG. 2 illustrates at 200 an example configuration of an optimized NFC antenna structure for reduced coupling in accordance with one or more aspects. In this example, the optimized NFC antenna structure 106 is implemented on a substrate 202, which may include or represent a circuit board, internal surface, ground plane, or other conductive layer of a computing device. As such, the illustrated optimized NFC antenna structure 106 may be on or above the substrate 202 of a computing device and under, below, or within a housing (e.g., non-conductive enclosure or exterior surface) that substantially defines a housing plane of the computing device. In aspects, the optimized NFC antenna structure 106 includes an NFC antenna 110 that at least partially overlaps a portion of a WLC 112. The WLC 112 may include a first coil with a conductor that forms a round or circular winding shape that is positioned substantially parallel to the housing plane of the computing device. The NFC antenna may include a second conductor (e.g., coil or winding) that forms another shape (e.g., triangular, trapezoidal, polygonal) that is positioned substantially parallel to the housing plane. As described herein, the NFC coil may generate a magnetic field when subject to an electric current and be positioned such that a portion of the magnetic field generated by the NFC coil is induced into the WLC through coupling between the coils (e.g., mutual induction).

As shown in FIG. 2, the optimized NFC antenna structure 106 may be implemented with a dielectric assembly of one or more sections or layers of dielectric material to increase magnetic field strength and/or improve performance of the NFC antenna 110 and/or WLC 112. In this example, the dielectric assembly includes a first section of dielectric material 204 positioned below the NFC antenna 110 and the WLC 112, and a second section of dielectric material 206 positioned below a portion of the NFC antenna 110. In aspects, the first section of dielectric material 204 may include a sheet or layer of nanocrystalline (NC) to improve isolation of radiation between the NFC antenna 110 and/or the WLC 112. The first section of dielectric material 204 (e.g., NC sheet) is not limited to the topography shown at 200 and may include various shapes that extend partially or wholly below the WLC 112 and/or partially below the NFC antenna 110. Generally, the NC sheet may contain NC materials including polycrystalline materials with crystallite sizes on the order of nanometers (nm). The second section of dielectric material 206 may include one or more ferrimagnetic materials (e.g., strontium, barium, manganese, nickel, zinc) to increase the magnetic field strength associated with the optimized NFC antenna structure and improve the inductive coupling to a receiving NFC antenna. In general, the dielectric sections or sheets may be used to reduce magnetic field loss and improve isolation of magnetic fields from, for instance, generating eddy currents in nearby conductive elements and/or surfaces.

In aspects of an optimized NFC antenna, conductors (e.g., coils, wires, traces) of the NFC antenna 110 may be formed in substantially non-circular shapes, which include polygons with at least three sections with angular or rounded corners (shown in relation to the housing plane 108). In some cases, the NFC antenna 110 is formed into a triangle shape or trapezoid shape with one or more sections that do not extend across the WLC 112 in an orthogonal fashion. In this example, the NFC antenna 110 includes a first section 208 that does not overlap the WLC 112 and is positioned over the second section of dielectric material 206 (e.g., ferrite layer). The NFC antenna 110 also includes a second section 210 and a third section 212 that extend at least partially over the WLC 112 with an angle between the second and third sections being in a range of 80 degrees to 160 degrees. The second section 210 and/or third section 212 may be positioned at least partially over a center, core, cavity, or internal diameter (e.g., a space or volume between windings) of the WLC 112. In some implementations, the angle between the second section 210 and the third section 212 is within a range of 130 degrees to 140 degrees. In aspects, the NFC antenna 110 may include a fourth section 214 that couples the third section 212 to the first section 208 (or any intermediate section) of the NFC antenna. The fourth section of the NFC antenna 110 may at least partially overlap the WLC 112 or be positioned such that the fourth section 214 does not overlap the WLC 112. As such, the NFC antenna 110 may be formed or configured generally in a trapezoid shape or isosceles trapezoid shape that partially overlaps the WLC 112. This is but one configuration of an optimized NFC antenna structure, which is further described along with other example configurations throughout this disclosure.

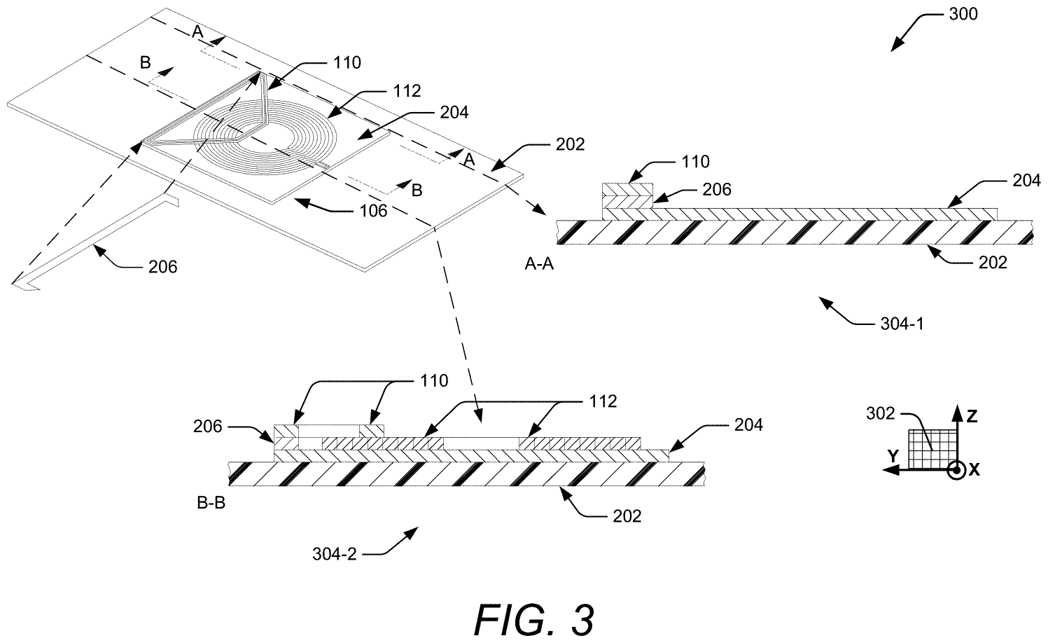

FIG. 3 illustrates at 300 cross-sectional views of an example optimized NFC antenna structure 106 that includes a WLC coil, an NFC coil, and a dielectric assembly configured in accordance with one or more aspects. The cross-sectional views shown at 300 are depicted with respect to a section plane 302 (e.g., a YZ plane) that is orthogonal to the housing plane 108. These views include a cross-sectional view 304-1 (view 304-1) along an edge (view line A-A) of the optimized NFC antenna structure and a cross-sectional view 304-2 (view 304-2) along a centerline (view line B-B) of the optimized NFC antenna structure. In the views illustrated, dimensions of each component (e.g., NFC antenna 110, WLC 112, dielectric material 204, dielectric material 206) are depicted by way of example only and are not limited to the relative dimensions, arrangement, or material stack-ups shown.

In the example view 304-1, a portion of the NFC antenna 110 (e.g., a first section) may be positioned over or overlap the first section of dielectric material 204 and the second section of dielectric material 206. Here, note that this portion of the NFC antenna 110 and/or the second section of dielectric material 206 is not positioned over or overlap the WLC 112. With reference to view 304-2, the WLC 112 is positioned over the first section of dielectric material 204 (e.g., NC sheet), which is shown in reference to the substrate 202 (e.g., device main logic board or ground plane). The NFC antenna 110 is positioned to partially overlap the WLC 112 and the second section of dielectric material 206 (e.g., ferrite layer). In some cases, the illustrated configuration of the NFC antenna 110 and WLC 112 provide a compact and space-efficient implementation that enables contactless communication and/or wireless charging functionalities.

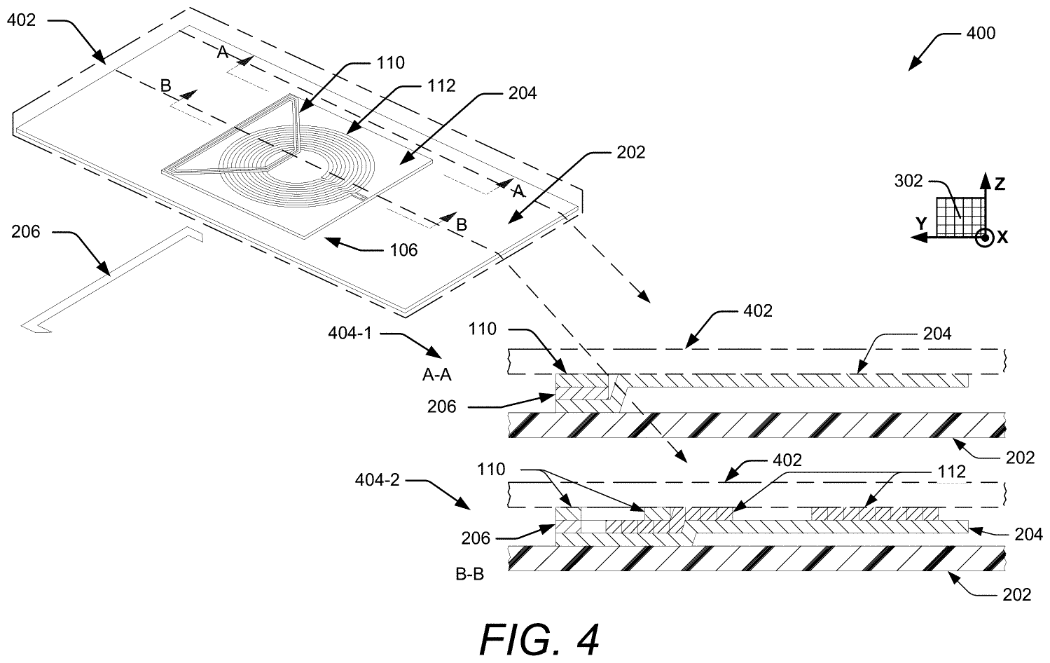

FIG. 4 illustrates at 400 cross-sectional views of another example optimized NFC antenna structure 106 that includes a WLC coil, an NFC coil, and a dielectric assembly configured in accordance with one or more aspects. Here, the optimized NFC antenna structure is shown illustrated in relation to housing 402, which may include a non-conductive or magnetic field-permeable surface of a computing device (e.g., back housing). The cross-sectional views shown at 400 are depicted with respect to the section plane 302 (e.g., a YZ plane) that is orthogonal to the housing plane 108. These views include a cross-sectional view 404-1 (view 404-1) along an edge (view line A-A) of the optimized NFC antenna structure and a cross-sectional view 404-2 (view 404-2) along a centerline (view line B-B) of the optimized NFC antenna structure. In the views illustrated, dimensions of the components (e.g., NFC antenna 110, WLC 112, dielectric material 204, dielectric material 206) are depicted by way of example only and are not limited to the relative dimensions, arrangement, or material stack-ups shown.

In the example view 404-1, the NFC antenna 110 and a portion of the first section of dielectric material 204 (e.g., NC sheet) may be positioned near or in contact with the housing 402. For example, one or more components of the optimized NFC antenna structure 106 may be assembled in relation to the housing 402 or the substrate 202 using various adhesives or fabrication techniques. In other words, the components of the optimized NFC antenna structure 106 may be assembled as a sub-assembly of coils and dielectric material (e.g., flexible circuits and dielectric layers), which is then assembled between the substrate 202 and the housing 402 (e.g., positioned or adhered to the housing or substrate).

With reference to view 404-2, the WLC 112 is also positioned near or against the housing 402 and below a portion of the NFC antenna 110. Here, note that a first portion of the WLC 112 is co-planar with the NFC antenna 110 and a second portion of the WLC 112 is positioned below a portion of the NFC antenna 110. As shown at 402-2, a contour of the first section of dielectric material 204 (e.g., NC sheet) may follow a general contour of components positioned above the first section, which include the NFC antenna, WLC 112, and the second section of dielectric material 206 (e.g., ferrite layer). As noted, the example configurations described herein may enable a compact and space-efficient implementation of the NFC antenna 110 and the WLC 112 in a device with reduced coupling.

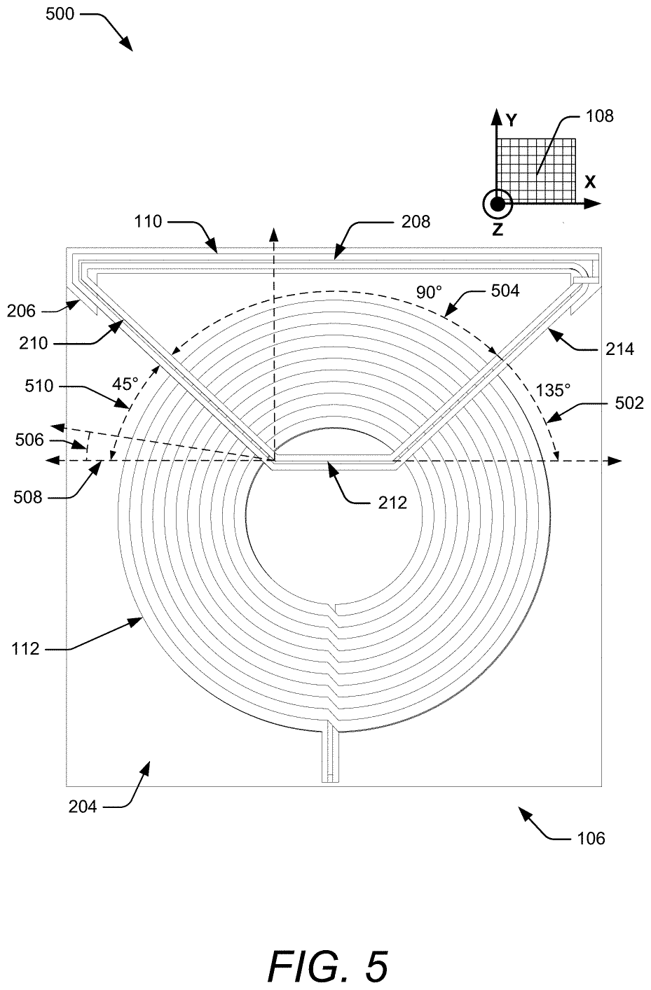

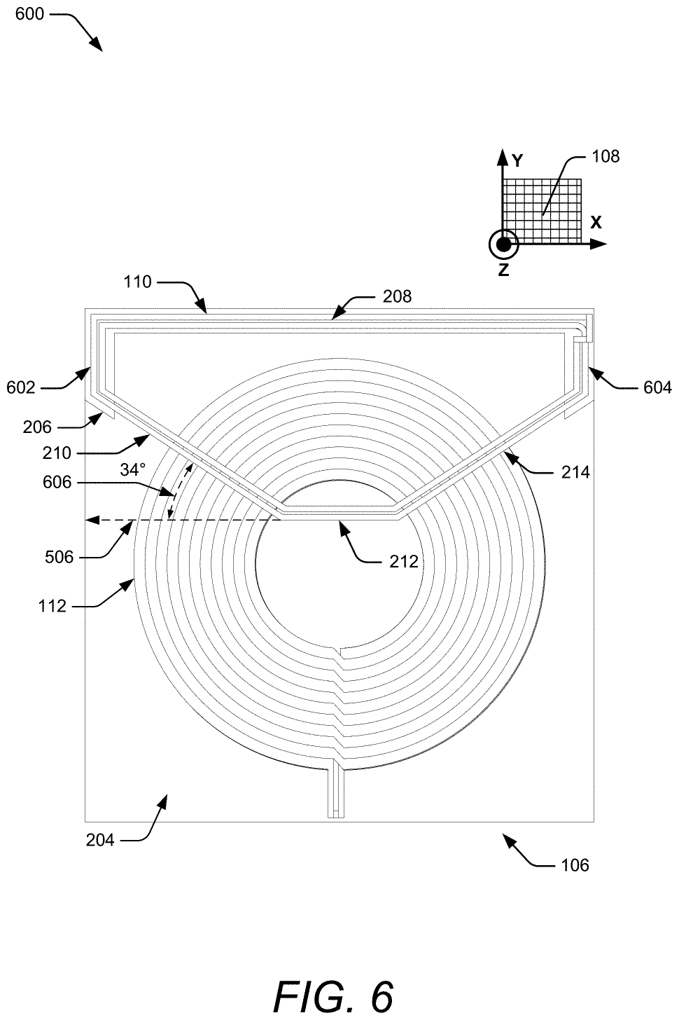

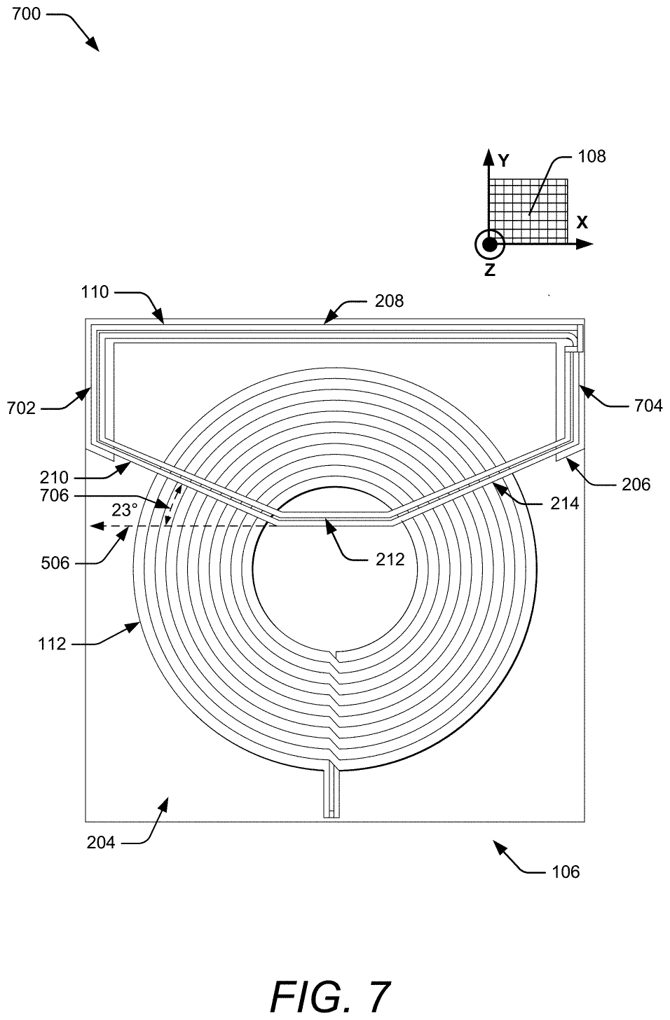

FIG. 5 illustrates at 500 a plan view of an example optimized NFC antenna structure implemented in accordance with one or more aspects. In aspects of an optimized NFC antenna structure, a geometry and/or positioning of the NFC antenna 110 may be configured to reduce coupling between the NFC antenna 110 and the WLC 112. FIGS. 5-8 generally illustrate and describe non-limited examples of an optimized NFC antenna structure with varying geometries. As described herein, the NFC antenna 110 may be implemented with four sections 208, 210, 212, and 214, with respective ends of the second section 210 and third section 212 coupled over the WLC 112. In some cases, the fourth section 214 is positioned over the WLC 112 and couples an end of the third section 212 to an end of the first section 208. Thus, a shape of the NFC antenna 110 may include a quadrilateral, trapezoid, isosceles trapezoid, and so forth. Although not shown, the NFC antenna 110 may also be implemented with three sections (e.g., without section 214, section 210 coupled directly to section 212) or with additional sections to form various polygonal shapes (e.g., FIGS. 6 and 7).

As shown at 500, the NFC antenna 110 can be configured with a second section 210 and a third section 212 that have an interior angle 502 (e.g., angle between the sections) that is within a range of 80 degrees to 160 degrees. In some cases, the NFC antenna 110 is configured such that an interior angle 504 between the second section 210 and the fourth section 214 is within a range of 85 degrees to 95 degrees. In this example, the NFC antenna 110 is implemented such that an interior angle between the second section 210 and the third section 212 is approximately 135 degrees. Alternatively, angular dimensions of the NFC antenna sections may be defined as an exterior angle 506 with reference to the third section 212 or an orthogonal line 508 across the WLC 112. Thus, in some cases, an exterior angle of the third section 212 and one of the second section 210 or fourth section 214 is in a range of ten degrees to 50 degrees. As shown in FIG. 5, the second section 210 and the third section 212 may have an exterior angle 510 of approximately 45 degrees. Although not specifically shown, the third section 212 and the fourth section 214 may also have a similar exterior angle of approximately 45 degrees. As described herein, the geometry of the NFC antenna 110, including respective lengths and angles of sections 210, 212, and/or 214, can be configured to reduce coupling between the NFC antenna 110 and the WLC 112.

FIG. 6 illustrates at 600 a plan view of another example optimized NFC antenna structure implemented in accordance with one or more aspects. In this example, the NFC antenna 110 includes a fifth section 602 coupled between the first section 208 and the second section 210, and a sixth section 604 coupled between the fourth section 214 and the first section 208. As shown in FIG. 6, the sections of the NFC antenna 110 may be configured such that the second section 210 and the third section 212 have an exterior angle 606 of approximately 34 degrees. Although not specifically shown, the third section 212 and the fourth section 214 may also have a similar exterior angle of approximately 34 degrees. Alternatively, any or all of the sections of the NFC antenna 110 may be configured with different lengths or exterior angles.

FIG. 7 illustrates at 700 a plan view of yet another example optimized NFC antenna structure implemented in accordance with one or more aspects. In this example, the NFC antenna 110 includes a fifth section 702 coupled between the first section 208 and the second section 210, and a sixth section 704 coupled between the fourth section 214 and the first section 208. As shown in FIG. 7, the NFC antenna 110 may be configured such that the second section 210 and the third section 212 may have an exterior angle 706 of approximately 23 degrees. Although not specifically shown, the third section 212 and the fourth section 214 may also have a similar exterior angle of approximately 23 degrees. Alternatively, any or all of the sections of the NFC antenna 110 may be configured with different lengths or exterior angles.

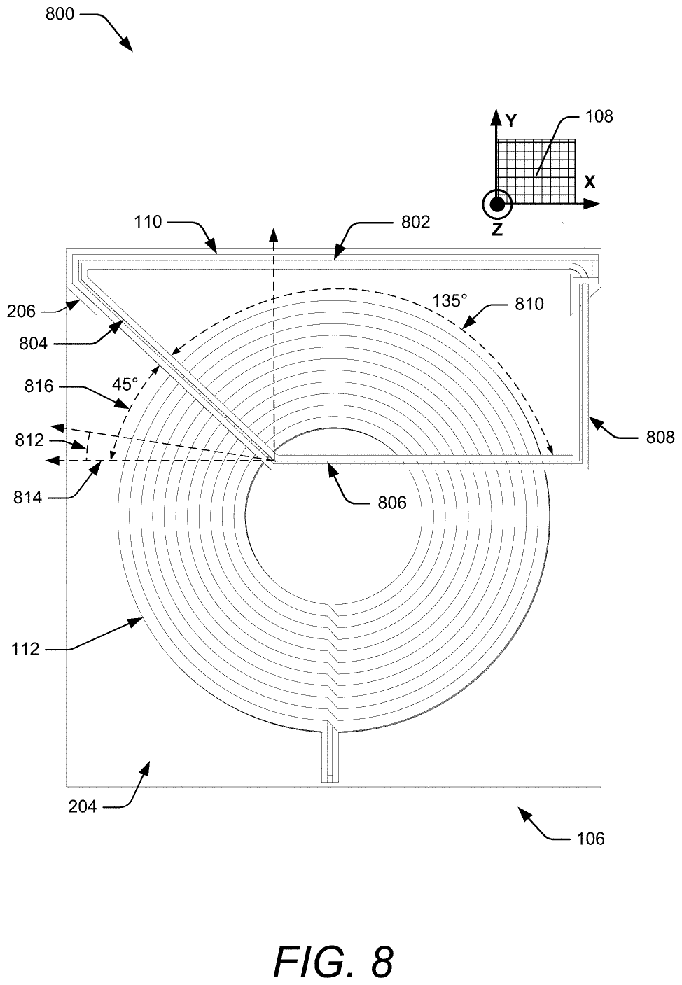

FIG. 8 illustrates at 800 a plan view of an example optimized NFC antenna structure that includes an asymmetric NFC coil in accordance with one or more aspects. As shown in FIG. 8, the NFC antenna 110 may be formed and/or positioned asymmetrically with respect to the WLC 112. In this example, the NFC antenna 110 is implemented with four sections 802, 804, 806, and 808, with respective ends of the second section 804 and third section 806 meeting or being coupled over the WLC 112. As shown in FIG. 8, the NFC antenna 110 is positioned or configured asymmetrically with respect to the WLC 112, with the first section 802 and fourth section 808 positioned to not overlap the WLC 112. Generally, a shape of the NFC antenna 110 may include a quadrilateral, polygon, trapezoid, and so forth. Although not shown, the NFC antenna 110 may also be implemented with three sections (e.g., without section 808, section 802 coupled directly to section 806) or with additional sections to form various polygonal shapes.

In aspects, the NFC antenna 110 can be configured such that an interior angle 810 between the second section 804 and the third section 806 (e.g., angle between the sections) is within a range of 80 degrees to 160 degrees. In some aspects, the angle between the second section 804 and the third section 806 of the NFC antenna 110 is within a range of 125 degrees to 145 degrees. In this example, the NFC antenna 110 is implemented such that an interior angle between the second section 804 and the third section 806 is approximately 135 degrees. Alternatively, angular dimensions of the NFC antenna sections may be defined as an exterior angle 812 with reference to the third section 806 or an orthogonal line 814 across the WLC 112. Thus, in some cases, an exterior angle of the second section 804 and the third section 806 is in a range of ten degrees to 50 degrees. As shown in FIG. 8, the second section 804 and the third section 806 may have an exterior angle 816 of approximately 45 degrees. Although not specifically shown, in some aspects (e.g., FIG. 5), the third section 806 and the fourth section 808 may also have a similar exterior angle of approximately 45 degrees. As described herein, the geometry of the NFC antenna 110, including respective lengths and angles of sections 802, 804, 806, and/or 808 (or additional sections), can be configured to reduce coupling between the NFC antenna 110 and the WLC 112.

Although an optimized antenna structure for reduced coupling has been described in language specific to features, it is to be understood that the subject of the appended claims is not necessarily limited to the specific techniques described herein. Rather, the specific techniques are disclosed as example implementations of an optimized antenna structure for reduced coupling between coils or antennas (e.g., an NFC coil and a WLC coil).

1. A computing device comprising:
a housing that substantially defines a housing plane of the computing device;
a battery positioned in the housing;
circuitry coupled to the battery and positioned in the housing;
a first coil coupled to the circuitry and comprising a first conductor having a first shape that is positioned substantially parallel to the housing plane and at least partially within the housing, the first shape forming a winding;
a second coil coupled to the circuitry and comprising a second conductor forming a second shape that is positioned substantially parallel to the housing plane and at least partially within the housing, the second coil usable to generate a magnetic field when subject to an electric current, the second coil at least partially overlapping the first coil, the second shape of the second coil comprising at least three sections that include:
a first section of the second coil that does not overlap the first coil;
a second section of the second coil coupled to a first end of the first section of the second coil, the second section extending over the first coil; and
a third section of the second coil coupled to a second end of the first section of the second coil, the third section positioned at least partially over the first coil and coupled to the second section of the second coil, an angle between the second section and third section being in a range of 80 degrees to 160 degrees.

2. The computing device as recited by claim 1, wherein the angle between the second section of the second coil and the third section of the second coil is in a range of 130 degrees to 140 degrees.

3. The computing device as recited by claim 1, wherein an exterior angle of the second section of the second coil and the third section of the second coil is in a range of 20 degrees to 80 degrees.

4. The computing device as recited by claim 1, wherein an exterior angle of the second section and the third section of the second coil is in a range of ten degrees to 50 degrees.

5. The computing device as recited by claim 1, wherein an exterior angle of the second section and the third section of the second coil is approximately 45 degrees.

6. The computing device as recited by claim 1, wherein an exterior angle of the second section and the third section of the second coil is approximately 34 degrees.

7. The computing device as recited by claim 1, wherein an exterior angle of the second section and the third section of the second coil is approximately 23 degrees.

8. The computing device as recited by claim 1, wherein the second section of the second coil and the third section of the second coil form a portion of the second coil that is positioned asymmetrically with respect to the first coil.

9. The computing device as recited by claim 1, further comprising:
a dielectric assembly configured to increase a strength of magnetic field of the first coil or the second coil, the dielectric assembly including two dielectric sections:
a first dielectric section positioned below the first coil and the second coil, the first coil and the second coil positioned between the housing plane and the first dielectric section; and
a second dielectric section positioned between a portion of the first section of the second coil and a portion of the first dielectric section.

10. The computing device as recited by claim 9, wherein:
a first dielectric section of a dielectric assembly comprises a nanocrystalline material; or
a second dielectric section of a dielectric assembly comprises a ferrite material.

11. The computing device as recited by claim 1, wherein the second shape of the second coil further comprises a fourth section positioned over the first coil, the fourth section coupling the third section of the second coil to the second end of the first section of the second coil.

12. The computing device as recited by claim 11, wherein the first section, second section, third section, and fourth section of the second shape of the second coil form a trapezoid or an isosceles trapezoid.

13. The computing device as recited by claim 1, wherein the first shape of the first coil comprises one of:
a circle;
an ellipse;
a rectangle;
a rectangle with rounded corners;
a square with rounded corners;
a stadium; or
a polygon with rounded corners.
